(19) United States
(12) Patent Application Publication
(10) Pub. No.: US 2011/0291830 A1
(43) Pub. Date: Dec. 1, 2011

(54) CLEANING INDICATOR, ASSOCIATED TEST SPECIMEN AND METHOD FOR TESTING CLEANING PROCESSES

(76) Inventor: Danja Kaiser, Glashutten (DE)

(21) Appl. No.: 13/148,180

(22) PCT Filed: Feb. 4, 2010
(86) PCT No.: PCT/EP2010/000686

§ 371 Date: Aug. 22, 2011

(30) Foreign Application Priority Data
Feb. 5, 2009 (EP) 09 001 639.5

(51) Int. Cl. G08B 21/00

(52) U.S. Cl. 340/540

(57) ABSTRACT

A cleaning indicator tests cleaning processes that facilitates a differentiated and gradual assessment of the cleaning processes. To this end, the cleaning indicator contains a plurality of indicator elements that are arranged on a common carrier and alter their properties depending on the cleaning action of a cleaning process, wherein the dependency on the cleaning action is selected differently for each of the individual indicator elements. Furthermore, a test specimen particularly suitable therefor is to be provided. In addition, a method for testing cleaning processes is to be provided, which facilitates a differentiated determination and testing of the cleaning action that is achieved.

The invention relates to a cleaning indicator for testing cleaning processes. It relates furthermore to an associated test specimen and to a method for testing cleaning processes.

Cleaning processes, in particular mechanical cleaning processes carried out in laboratories and hospitals, serve to remove sometimes highly tenacious dirt and deposits from, for example, medicinal instruments or laboratory equipment. The cleaning is customarily carried out in automatic cleaning machines, the manner of operation of which resembles that of customary domestic washing machines. Said appliances are referred to as cleaning-disinfection appliances (CDA). Said appliances carry out various washing processes, optionally in combination with disinfection steps (pre-washing, cleaning, disinfecting and rinsing). Reusable medicinal appliances and laboratory equipment, in particular surgical instruments, additionally have to be sterilized prior to being used. In the case of aseptic applications, the use of sterile tools, instruments and materials is vital. To this end, the cleaning process is followed by a sterilization process.

In order to evaluate whether a cleaning process has been successful, use may be made of indicators which comprise, for example, what are referred to as test soils. Said indicators customarily comprise layers of a suitable material which simulates the soil of the load to be cleaned, and are applied to a waterproof carrier material. Said layers are generally colored. Examples of materials suitable for said coatings include, depending on requirements, blood components, protein, polysaccharides, polysugars or milk proteins. A synthetic test soil is known, for example, from EP 0 886 778 B1.

The different soils require different standards of the cleaning action or cleaning performance of the cleaning process. The efficiency of the cleaning process is therefore dependent on the type of soiling. In this connection, the cleaning action is provided as an integral variable which follows from an interaction of, for example, duration, temperature, pressure, spraying conditions, cleaning chemicals and other cleaning parameters.

When indicators of this type are used, it can be established by means of a visual checking of the indicator carrier after the cleaning process whether the indicator substance has been completely washed away. The cleaning indicators currently on the market do not permit more precise or gradual details regarding the conditions during the cleaning operation and the cleaning success obtained, since standard specifications have been completely lacking until now.

The EN ISO 15883 series of standards is concerned very generally with the themes of cleaning and disinfection. However, it does not contain any statements regarding specific test methods. Approx. 30 different test soils are listed in the technical information of EN ISO 15883-5. However, no statement is made in this connection regarding the degree of difficulty of removing said coatings during a cleaning process.

The invention is therefore based on the object of providing a cleaning indicator which permits a differentiated and reproducible testing of cleaning processes. Furthermore, test specimens which are particularly suitable for this purpose are to be provided. Furthermore, a method for evaluating and testing cleaning processes is to be provided, the method permitting a differentiated determination and checking of the cleaning result obtained.

With regard to the cleaning indicator, this object is achieved according to the invention by the cleaning indicator comprising a plurality of indicator elements which are applied to a common carrier and change the properties thereof depending on the cleaning action of a cleaning process, wherein the dependency on the cleaning action is selected differently for each of the individual indicator elements. This means in particular that the individual indicator elements react with differing sensitivity to the performance of the cleaning process.

Advantageous refinements of the invention are the subject matter of the dependent claims.

The invention is based on the consideration that cleaning processes can be characterized by the cleaning performance thereof. The cleaning should be matched to the properties of the dirt to be removed and the particular standards regarding the thoroughness of the cleaning. Only in this way can it firstly be ensured that the dirt is actually also removed and, secondly, given less stringent requirements with regard to the cleaning performance, material, energy and time can be effectively saved. It should be noted here that, in cleaning processes as typically occur in laboratories and hospitals, it is customary for different soilings—with different standards required of the cleaning—to occur simultaneously and have to be removed.

In order to be able to match the cleaning performance in a specific manner to the actual requirements and, after the cleaning process has ended, to be able to test the success thereof, an effective test method is therefore required, the test method not only qualitatively indicating the cleaning success obtained but, furthermore, enabling the latter to be quantifiable in as simple a manner as possible. Such a quantification should be reproducible, if possible, and free from arbitrary assessment ranges. As it has now turned out, said requirements can only be inadequately met by the cleaning indicators known to date. Due to a lack of reference soil, the indicators on the market have entirely different properties and therefore impart different and noncomparable results during the testing of the cleaning performance of a cleaning process. The differentiated, gradual evaluation of the cleaning action obtained within the context of a calibratable reference measurement is therefore not possible.

Starting from the finding that a cleaning indicator should be designed for a gradual indication and evaluation of the cleaning performance in order to avoid the disadvantages mentioned above, it is now provided that the cleaning indicator is equipped with a plurality of indicator elements which are applied to a carrier and can be exposed simultaneously and in the same manner to a cleaning process and which react or respond to a certain extent with different sensitivity to the crucial cleaning parameters. In this case, the indicator elements change the properties thereof or the structure thereof depending on the cleaning action of the cleaning process. The indicator elements react in a different manner and/or with different strength to one and the same cleaning reaction by said dependency, or the sensitivity, with regard to the crucial cleaning parameters or the integral cleaning performance being designed differently for each of the individual indicator elements, which can be realized, for example, by means of a suitable variation of the physical or chemical structure parameters or by suitable selection of material for the indicator substance. Depending on how many or to which extent the indicators change the properties thereof in a cleaning process, a conclusion can thus be drawn in the manner of a discretized assessment of the cleaning performance of the process. A gradual, quantitatively graduated statement regarding the cleaning performance is therefore made possible. On the basis of such a quantification, individual cleaning processes can be assessed and the level of performance thereof matched to the application. Changes of the cleaning performance of a process can therefore be identified from cleaning batch to cleaning batch. By means of tests having different levels of performance, calibrated reference data can also be obtained and can then be used later to assess or test cleaning processes. The change of the properties of the individual indicator elements leads to an indication which differs in each case and which can be used for assessing the cleaning action.

In a preferred embodiment, the indicator elements change the properties thereof as soon as the cleaning action reaches a predetermined desired value. In this case, different desired values are assigned to each of the individual indicator elements. In many cases, it is of interest whether the cleaning action has reached or exceeded or fallen short of a certain desired value and therefore also of a certain threshold. In this embodiment, a quantized detection of the cleaning action is therefore possible to a certain extent.

The indicator elements here can be arranged with regard to the desired values thereof and can be arranged, for example, next to one another or one above another in a rising or falling sequence. Furthermore, depending on requirements, other arrangements may also be preferred. A suitable indicator element arrangement which is matched to the requirements permits a rapid and effective evaluation of the cleaning operation by inspection of the indicator elements.

Liquids, such as water or cleaning solutions which have a suitable chemical composition, can be used as the cleaning medium. However, depending on requirements, a different selection may also be made, for example in the case of steam cleaning in which the cleaning medium is in a vapor state.

The changing of the indicator elements preferably takes place in an irreversible manner. It is thus possible, after the cleaning operation has ended, to reliably detect that a predetermined cleaning action or cleaning performance, to which at least one of indicator elements has reacted, has been achieved, at least temporarily, during the cleaning process. If the indicator elements are designed, for example, in such a manner that they change irreversibly upon reaching a certain cleaning performance and if at least one indicator element is not changed during the cleaning process, the maximum cleaning action of the cleaning process can be inferred.

The change of the properties of the indicator elements may comprise a change in color. If the change of the properties of the indicator elements and therefore the change in color are visually perceptible, an estimation of the cleaning action can be obtained with little outlay by inspection of the cleaning indicator after the cleaning operation has ended.

The change of the properties of the indicator elements advantageously comprises the dissolution thereof in a cleaning medium used in the cleaning process. This means, for example, that said indicator elements differ in terms of solubility with regard to the cleaning medium. The dissolution of an indicator element can be established in a simple manner. In particular given a suitable arrangement of the indicator elements, visual checking of the cleaning performance can be rapidly carried out.

The indicator elements may differ by the respective chemical crosslinkages thereof or adhesion to the carrier. This enables different changes to the structure of the indicator elements, for example of the solubility properties thereof with regard to the cleaning medium, to be realized. Furthermore, the indicator elements may also differ from one another in the application thickness thereof or in the spatial extents thereof. In particular, indicator elements may be applied to the carrier in the form of dots or strips.

A differentiated statement regarding the cleaning action can be obtained in particular if the indicator elements are applied to the carrier in a manner printed successively and/or one above another. A lateral arrangement of the indicator elements on the carrier permits an overall view of the properties of the indicator elements and therefore of the indication thereof, and thus rapid checking of the cleaning action. If the indicator elements are fitted to the carrier one above another and thereby to a certain extent form bundles, the statements regarding the cleaning performance can be achieved in an alternative manner. If the indicator elements are fitted one above another, for example with falling cleaning performance, and if said indicator elements dissolve in the cleaning medium when the cleaning performance is reached, the cleaning action can be determined with reference to the indicator elements which are still present on the carrier after the cleaning process. The layer thickness of the indicator elements still remaining can be used to a certain extent as a measure of the cleaning performance obtained. In this case, the configurations in which the indicator elements are fitted on the carrier next to one another or one above another can advantageously be combined.

Furthermore, it has proven advantageous to fit the indicator elements on the carrier one above another in a different sequence. Each of said bundles of indicator elements represents a different standard required of the cleaning action and accordingly delivers a different indication. If, for example, in one bundle the indicator element printed uppermost corresponds to the highest standard required of the cleaning performance, then said cleaning performance has to be achieved so that said indicator element dissolves, and the indicator elements located therebelow can dissolve. In this manner, it can be reliably established upon complete dissolution of the bundle that the appropriate cleaning performance has been reached. By means of a plurality of such bundles on a common carrier, in which the indicator elements are each preprinted in a different sequence, the cleaning actions which have occurred in the cleaning process can be reliably inferred. If all of the indicator elements in all of the bundles have dissolved, it is highly probable that all of the desired cleaning performances and cleaning actions have been achieved.

According to the invention, the indicator elements are applied to a common carrier. The application can be brought about by means of a standard printing process. In particular, offset printing, flexographic printing or screen printing are suitable for this purpose. By means of the production in a preprinting process, a plurality of different indicator elements can be printed on the carrier successively, thus enabling cost-effective and simply reproducible production of the cleaning indicator. The carrier advantageously consists of waterproof material; a laminate of paper and plastic, metal foil or a metal foil laminate are suitable in particular for this purpose.

The cleaning indicator preferably comprises between two and ten, and in particular five indicator elements. The number of indicator elements depends on the requirements and the dissolution, and also on the accuracy with which the cleaning operation and the cleaning performance which has taken place are intended to be determined.

With regard to the test specimen, the abovementioned object is achieved by the test specimen comprising an obstacle for a cleaning medium and a detector volume connected to said obstacle. The detector volume here accommodates a cleaning indicator according to the invention.

Test specimens or test specimen systems can advantageously be used for checking the cleaning performance of a cleaning process. In test specimen systems of this type, the comparatively inaccessible interior surface of complex instruments is simulated by a suitable model via which the success of the cleaning measure can be checked in an analogous manner even for comparatively complex instruments. If, when such a system is used, the cleaning indicator which is fitted in the test specimen indicates that a cleaning action has taken place, it can be assumed that—optionally taking into consideration a suitably selected safety supplement—there must have been sufficient contact with the cleaning medium in the instruments to be cleaned, even at the most inaccessible points of the interior surface thereof.

The test specimen is preferably designed as a hollow body, wherein the material of the test specimen borders the detector volume and the obstacle. The cleaning indicator is located in the detector volume within the casing. It has proven particularly advantageous here if the obstacle and/or detector space are designed as tube lengths. A cleaning indicator, which may also be considered to be a detector, is connected on the input side to a tube, the length of which is suitably selected and which is held open at the inlet end thereof for cleaning medium. In this case, the tube or hollow body models the behavior of similarly configured interior surfaces in the instruments provided for cleaning.

The test specimen advantageously has a plurality of tube lengths having a different cross section and/or volume. This is motivated by the fact that, in the case of customary test specimens, a high detection sensitivity can be achieved only with an obstacle of appropriately large dimensions and therefore precisely at the cost of compactness. Therefore, for a compact construction, the supply of cleaning medium to the detector volume should be provided in multiple stages. Each of said stages has a different cross section. The pressure and flow rate change here depending on the cross section. In the event of an increase in the cross section, the flow rate is therefore automatically reduced and the mechanical cleaning performance is therefore decreased. More difficult cleaning conditions could therefore be simulated.

If a hollow test specimen is provided with a loose bed through which a flow can pass, as use is frequently made of in column chromatography, the fill may also be covered by a cleaning indicator. The detection of the cleaning indicator on the bulk volume can be evaluated either by emptying the bulk volume or by a transparent wall of the test specimen. The obstacle of the test specimen is configured in at least two stages, but optionally also in multiple stages, the stages differing from one another with regard to the dimensioning thereof, i.e. in particular with regard to the respective volume and/or cross section thereof. The stage directly adjacent to the detector volume can serve to model the accessibility to the particularly inaccessible interior surfaces of the instrument requiring treatment.

In general, the test body is preferably configured in such a manner that it can simulate the properties of solid instruments and/or hollow bodies, depending on requirements. The use of different test specimens enables different flow conditions, spray shadows and further characteristic influences on the load and load aids to be simulated in the CDA.

With regard to the method, the abovementioned object is achieved by a cleaning indicator being exposed to a cleaning process either within a test specimen or without test specimens, wherein, after the cleaning process has ended, the cleaning indicator is supplied to an analyzing unit which analyzes the change in the properties of the indicator elements by the cleaning process, and wherein a characteristic value for the cleaning action obtained with the cleaning process is derived from the analytical data.

Said characteristic value can furthermore be passed on to an output unit. The output unit can output the characteristic value in a desired format or in a suitable depiction. In this case, for example, numbers and/or audiovisual signals can be output. The output here may take place on a display, may initiate a printing operation, or may take place with the aid of a sound output.

In a preferred embodiment of the method, the properties of the indicator elements after the cleaning process are compared with the original properties thereof with reference to reference data. The reference data may be present, for example, in a suitably stored and retrievable form. Furthermore, the reference data may have been calibrated beforehand. In particular, the inclusion of calibrated reference data permits a quantitative rating and evaluation of the cleaning process.

The method can be carried out, for example, in such a manner that, after the cleaning operation has ended, the analyzing unit determines the number of indicator elements, the properties of which have changed during the cleaning process. The characteristic value which characterizes the cleaning action obtained can then be formed from said number. If the behavior of the indicator elements under certain conditions of the cleaning process is known, and if in particular calibrated reference data are present, then, for example, the number of indicator elements, the properties of which have changed can be depicted on a cleaning performance range—which is known by calibration.

The analysis of the properties of the indicator elements in the analyzing unit can be implemented by computer-assisted methods. If the indicator elements are configured in such a manner that they dissolve in the cleaning medium, it can be determined by means of a pattern identification algorithm, for example by identification of dark surfaces in relation to light surfaces, which indicator elements have dissolved. If the indicator elements are configured for a change in color, an automatic identification of the color can interpret the structure of the indicator elements. In this case, changes in color in the UV or infrared range of light can be detected with sensors which are configured for said wavelength ranges.

One or more cleaning indicators, optionally in combination with a suitable test specimen, together with an analyzing unit and, if required, an output unit will be understood as forming a measuring system for measuring the cleaning performance of cleaning processes.

The advantages obtained by the invention consist in particular in that a gradual statement regarding the cleaning performance is made possible by a plurality of indicator elements reacting differently on a common carrier to the cleaning process. As a result, the cleaning performance can be matched individually to the standards required, and material, energetic and time resources can be saved. By various options for the property changes of the indicator elements, the cleaning indicator according to the invention can be used flexibly and can be matched individually to the testing task. In addition, an insertion of the cleaning indicator into a test specimen permits the analysis of the cleaning performance with regard to different types of instruments.

An exemplary embodiment is explained with reference to a drawing, in which, in a highly schematized illustration:

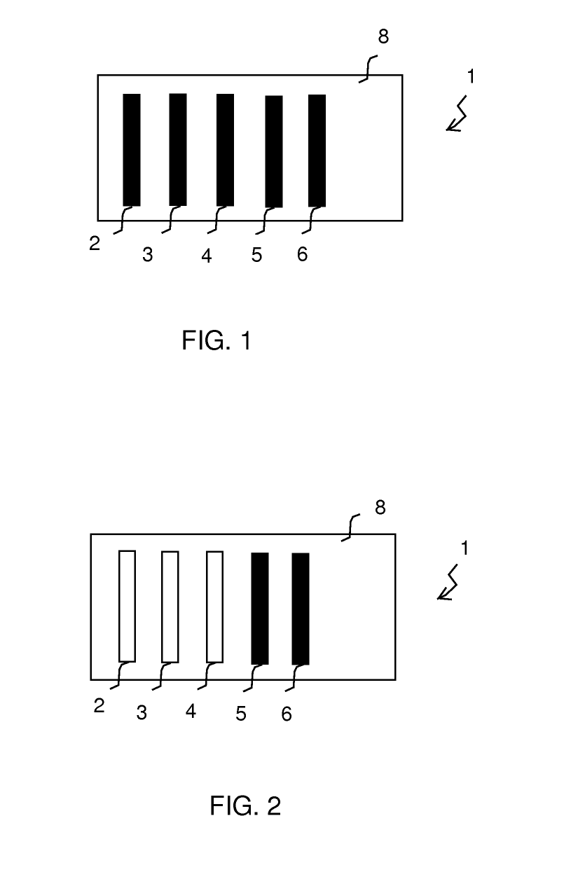

FIG. 1 shows a top view of a cleaning indicator with a first display,

FIG. 2 shows a top view of the cleaning indicator according to FIG. 2 with a second display, and

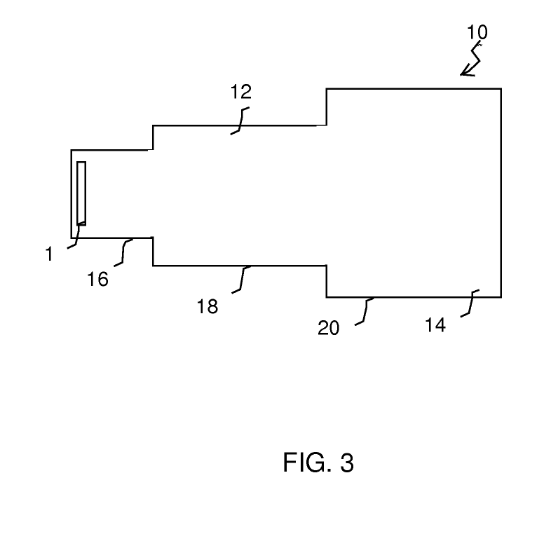

FIG. 3 shows a cross section through a test specimen into which the cleaning indicator according to FIGS. 1 and 2 is inserted.

Identical parts are provided with the same reference numbers in all of the figures.

The cleaning indicator 1 illustrated in FIG. 1 is provided with five indicator elements 2, 3, 4, 5, 6 which are applied to a common carrier 8. The cleaning indicator 1 here is intended to have the original properties thereof—before treatment by a cleaning process—and therefore the original display thereof. The five indicator elements 2, 3, 4, 5, 6 here are configured in such a manner that they have different solubilities in the cleaning medium used in the cleaning process. Provision is made here for the respective indicator element 2, 3, 4, 5, 6 to completely dissolve if the cleaning action of the cleaning process reaches a desired value assigned to the indicator element 2, 3, 4, 5, 6. In this example, the indicator elements 2, 3, 4, 5, 6 are arranged on the carrier 8 from the left to the right with increasing sensitivity with regard to the cleaning action. Depending on requirements, other arrangement options are also conceivable and desirable. Alternatively, the indicator elements 2, 3, 4, 5, 6 can be arranged, for example, in a decreasing sequence or one above another instead of next to one another.

One possible display of the cleaning indicator 1 after a cleaning process is shown in FIG. 2. The indicator elements 2, 3, 4 have dissolved from the carrier 8. The indicator elements 5, 6 are still completely present. It can therefore be concluded in this example that, during the cleaning process, one or more parameters of the cleaning process located between the desired value, which is assigned to the indicator element 4, and the desired value, which is assigned to the indicator element 5, have not been reached. If the changes of the structure of indicator elements configured in such a manner have been calibrated previously in test cleaning processes, a quantitative statement regarding the cleaning action achieved can be made.

A test specimen 10 designed for accommodating a cleaning indicator 1 is illustrated in FIG. 3. The test specimen 10 comprises an obstacle 12 for the cleaning medium and an end mouth 14 through which the cleaning medium enters. The tubular section 16, which is also referred to as the detector volume, accommodates the cleaning indicator 1. In this case, the test specimen 10 is constructed from a plurality of tubular sections 16, 18, 20, the cross section of which increases at increasing distance from the cleaning indicator 1. Of course, it is also possible, as an addition to such a three-stage design, for further stages to be consecutively connected, or a single-stage or two-stage design can be provided. By selecting the number and dimensions of the various sections, different conditions of the cleaning process and different properties of instruments of various configuration can be simulated and tested. A test specimen may also be designed to accommodate a plurality of identically or differently configured cleaning indicators.

### LIST OF REFERENCE NUMBERS

1 Cleaning indicator
2, 3, 4, 5, 6 Indicator elements
8 Carrier
10 Test specimen
12 Obstacle
14 End mouth
16 Detector volume
18, 20 Section

1-26. (canceled)

27. A cleaning indicator for testing cleaning processes, the cleaning indicator comprising:
a common carrier; and
a plurality of indicator elements applied to said common carrier and change properties thereof depending on a cleaning action of a cleaning process, wherein a dependency on the cleaning action is selected differently for each of individual said indicator elements.

28. The cleaning indicator according to claim 27, wherein said indicator elements change said properties thereof as soon as the cleaning action reaches a predetermined desired value, and wherein different desired values are assigned to each of said indicator elements.

29. The cleaning indicator according to claim 28, wherein said indicator elements are ordered with regard to desired values thereof.

30. The cleaning indicator according to claim 27, wherein the change of said properties is irreversible.

31. The cleaning indicator according to claim 27, wherein the change of said properties includes a color change and is visually perceptible.

32. The cleaning indicator according to claim 27, wherein the change of said properties includes a dissolution of a respective one of said indicator elements in a cleaning medium used in the cleaning process.

33. The cleaning indicator according to claim 27, wherein said indicator elements have differing adhesion to said common carrier.

34. The cleaning indicator according to claim 27, wherein said indicator elements have different application thicknesses.

35. The cleaning indicator according to claim 27, wherein said indicator elements have different properties and are disposed on said common carrier in a manner printed successively and/or one above another and thus permit a differentiated statement regarding the cleaning action.

36. The cleaning indicator according to claim 27, wherein said indicator elements have different properties and are disposed on said carrier in a manner printed one above another in a different sequence, thus resulting in different standards being required of the cleaning action.

37. The cleaning indicator according to claim 27, wherein said indicator elements are applied to said common carrier by a standard printing process selected from the group consisting of offset printing, flexographic printing and screen printing.

38. The cleaning indicator according to claim 27, wherein said common carrier is formed from a material selected from the group consisting of a plastic, a waterproof laminate of paper and plastic, a metal foil and a metal foil laminate.

39. The cleaning indicator according to claim 27, wherein a number of said indicator elements is in a range of two to ten.

40. The cleaning indicator according to claim 27, wherein a number of said indicator elements is five indicator elements.

41. A test specimen, comprising:
an obstacle for a cleaning medium used in a cleaning process;
a cleaning indicator for testing cleaning processes, said cleaning indicator having a common carrier and a plurality of indicator elements applied to said common carrier and change properties thereof depending on a cleaning action of the cleaning process, wherein a dependency on the cleaning action is selected differently for each of said indicator elements; and
a detector volume connected to said obstacle and accommodates said cleaning indicator.

42. The test specimen according to claim 41, wherein the test specimen is configured in a form of a hollow body.

43. The test specimen according to claim 42, wherein at least one of said detector volume or said obstacle is configured as a tube.

44. The test specimen according to claim 42, wherein said obstacle has a bulk material filling.

45. The test specimen as claimed in claim 44, wherein said cleaning indicator is applied directly to said bulk material filling.

46. The test specimen according to claim 42, further comprising a transparent material such that a result of testing can be detected without opening the test specimen and removing said cleaning indicator.

47. The test specimen according to claim 43, further comprising a plurality of volume sections of different cross section and/or volume.

48. The test specimen according to claim 41, wherein the test specimen is configured as a sieve.

49. The test specimen according to claim 41, wherein the test specimen has gaps formed therein.

50. A method for testing cleaning processes, which comprises the steps of:
providing a cleaning indicator having a common carrier and a plurality of indicator elements applied to the common carrier and change properties thereof depending on a cleaning action of a cleaning process, wherein a dependency on the cleaning action is selected differently for each of said indicator elements;
exposing the cleaning indicator to the cleaning process;
after the cleaning process has ended, supplying the cleaning indicator to an analyzing unit which analyzes a change in the properties of the indicator elements by the cleaning process resulting in analytical data; and
deriving a characteristic value for the cleaning action obtained with the cleaning process from the analytical data.

51. The method according to claim 50, which further comprises comparing the properties of the respective indicator element after the cleaning process with original properties selected from the group consisting of stored reference data and calibrated reference data.

52. The method according to claim 50, which further comprises defining a characteristic value depending on a number of the indicator elements, the properties of which have changed after the cleaning process.

53. The method according to claim 50, which further comprises analyzing the properties of the indicator elements with computer-assisted methods for identifying a color or a pattern.

54. The method according to claim 50, which further comprises exposing the cleaning indicator to the cleaning process in a test specimen, the test specimen containing:
an obstacle for a cleaning medium used in the cleaning process;
the cleaning indicator; and
a detector volume connected to said obstacle and accommodates said cleaning indicator.
